(19) United States
(12) Patent Application Publication
(10) Pub. No.: US 2014/0234617 A1
(43) Pub. Date: Aug. 21, 2014

(54) INSULATING FILM

(71) Applicants: Shunsuke Masaki, Ibaraki-shi (JP); Toshimasa Nishimori, Ibaraki-shi (JP); Hiroyuki Fujita, Ibaraki-shi (JP); Kazunori Hayashi, Sakai-shi (JP); Jun Fujiki, Sakai-shi (JP)

(72) Inventors: Shunsuke Masaki, Ibaraki-shi (JP); Toshimasa Nishimori, Ibaraki-shi (JP); Hiroyuki Fujita, Ibaraki-shi (JP); Kazunori Hayashi, Sakai-shi (JP); Jun Fujiki, Sakai-shi (JP)

(73) Assignee: NITTO DENKO CORPORATION, Ibaraki-shi, Osaka (JP)

(21) Appl. No.: 14/239,952

(22) PCT Filed: Jun. 29, 2012
(86) PCT No.: PCT/JP2012/066735

§ 371 Date: Apr. 22, 2014

(30) Foreign Application Priority Data
Aug. 25, 2011 (JP) 2011-183462
May 28, 2012 (JP) 2012-120619

(51) Int. Cl. H01B 3/30

(52) U.S. Cl. CPC H01B 3/306
USPC 428/338

(57) ABSTRACT

Provided is an insulating film which is excellent in heat resistance and discharge deterioration resistance and has a long insulation life. The insulating film includes a heat-resistant resin and insulating fine particles dispersed in the heat-resistant resin. The inscribed circles of regions, which are free of the insulating fine particles, have an average diameter of 80 to 900 nm.

### TECHNICAL FIELD

The present invention relates to an insulating film excellent in heat resistance and discharge deterioration resistance.

### BACKGROUND ART

In recent years, a voltage to be used has tended to increase in, for example, automobile motors, industrial motors, and inverters for large equipment, and hence there has been a demand for high heat resistance and voltage resistance in an insulating material to be used in those motors and inverters.

The voltage resistance of the insulating material is degraded with the passage of time owing to the influence of heat deterioration and discharge deterioration. Specifically, regarding the discharge deterioration, when a defect such as a small void, crack, or flaw is present in the insulating material, weak discharge, that is, partial discharge (corona discharge) is caused in the defect by the application of a voltage. It is considered that, when the partial discharge is repeated, local breakdown occurs, which is gradually developed in a dendritic pattern, finally resulting in dielectric breakdown. Further, a dendritic breakdown mark in this case is called an electrical tree.

As a countermeasure against the discharge deterioration, there is known an insulating material containing a resin and insulating fine particles dispersed in the resin (Patent Literature 1). An insulating electric wire covered with such insulating material exhibits resistance to discharge deterioration because the insulating fine particles suppress the development of an electrical tree in the covering layer.

However, there is a further demand for an insulating material which has high resistance to heat deterioration and discharge deterioration and has a long insulation life.

### CITATION LIST

### Patent Literature

[PTL 1] JP 3496636 B2

### SUMMARY OF INVENTION

### Technical Problem

The present invention has been made in view of solving the above-described problems, and an object of the present invention is to provide an insulating film which is excellent in heat resistance and discharge deterioration resistance and has a long insulation life.

### Solution to Problem

The inventors of the present invention have earnestly studied, and consequently found that the above-mentioned object can be achieved by regulating the dispersion state of insulating fine particles in a heat-resistant resin, thereby achieving the present invention.

An insulating film of the present invention includes: a heat-resistant resin; and an insulating fine particle dispersed in the heat-resistant resin, in which an average diameter of inscribed circles of regions, which are free of the insulating fine particle is from 80 to 900 nm.

According to a preferred embodiment, the heat-resistant resin contains a polyimide resin or a polyamide imide resin.

According to a preferred embodiment, the insulating fine particle has an average primary particle diameter of 200 nm or less.

According to a preferred embodiment, the insulating fine particle contains at least one component selected from silica, alumina, and titania.

### Advantageous Effects of Invention

According to one embodiment of the present invention, the insulating film which is excellent in heat resistance and discharge deterioration resistance and has a long insulation life can be provided.

### BRIEF DESCRIPTION OF DRAWINGS

FIG. 1 are diagrams illustrating image processing for obtaining an average diameter of inscribed circles of regions, which are free of insulating fine particles.

FIG. 2 is a schematic diagram of a circuit in measurement of an insulation life time.

FIG. 3 is a schematic view illustrating an electrode arrangement in measurement of an insulation life time.

FIG. 4 is a graph showing a relationship between an average diameter of inscribed circles of regions, which are free of insulating fine particles and an average insulation life time.

### DESCRIPTION OF EMBODIMENTS

[Insulating Film]

An insulating film of the present invention includes a heat-resistant resin and insulating fine particles dispersed in the heat-resistant resin. In the insulating film of the present invention, an average diameter of inscribed circles of regions, which are free of the insulating fine particles, is 900 nm or less, preferably 700 nm or less, more preferably 600 nm or less, still more preferably 500 nm or less, particularly preferably 400 nm or less. When the average diameter of inscribed circles of regions, which are free of the insulating fine particles, is 900 nm or less, the insulating fine particles satisfactorily exhibit resistance to discharge deterioration, and hence a period of time required for the film to be subjected to dielectric breakdown (also referred to as “insulation life time”) can be made sufficiently long. Note that a preferred lower limit value of the average diameter of the inscribed circles can be set appropriately considering mechanical characteristics and the like of an insulating film to be obtained. Specifically, the average diameter of inscribed circles is 80 nm or more, preferably 90 nm or more. When the average diameter is less than 80 nm, defects such as micro cracks occur in the film, and hence insulating property is degraded.

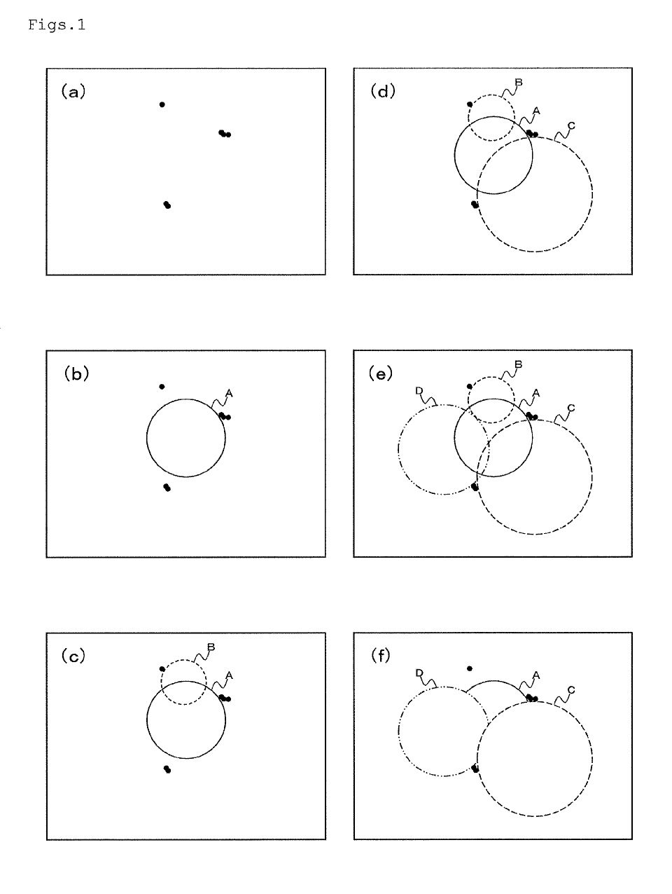

In the present invention, the “average diameter of inscribed circles of regions, which are free of insulating fine particles,” is determined as follows. That is, the cross-section of the insulating film is observed with a transmission electron microscope (TEM) to obtain image data. A pixel at any appropriate one point is selected from a matrix portion (resin portion) of the image data, and a circle is drawn with the point being the center. The diameter of the circle is enlarged until the circumference comes into contact with an insulating fine particle present most closely to the point, and the image data is overwritten with a circle which is obtained when the circumference comes into contact with the insulating fine particle as an “inscribed circle of a region, which are free of insulating fine particles.” This operation is performed with respect to all the pixels of the matrix. Note that, in the case where a newly drawn inscribed circle overlaps one or more inscribed circles which have already been drawn, the following processing is performed: (1) in the case where the newly drawn inscribed circle overlaps an existing inscribed circle having a diameter equal to or less than that of the newly drawn inscribed circle, the image data is overwritten with the new inscribed circle; and (2) in the case where the newly drawn inscribed circle overlaps an existing inscribed circle having a diameter more than that of the newly drawn inscribed circle, the image data is not overwritten with the new inscribed circle. Thus, in the case where the newly drawn inscribed circle overlaps both the inscribed circle having a diameter equal to or less than that of the newly drawn inscribed circle and the inscribed circle having a diameter more than that of the newly drawn inscribed circle, the image data is overwritten with a region other than the region overlapping the inscribed circle having a diameter more than that of the newly drawn inscribed circle. Hereinafter, as a specific example, image processing illustrated in FIG. 1(a) is described. Note that black points in FIG. 1(a) represent insulating fine particles. First, as illustrated in FIG. 1(b), any one point is selected and an inscribed circle A of a region, which is free of the insulating fine particles, is drawn. Then, as illustrated in FIG. 1(c), another point is selected and an inscribed circle B is drawn. In this case, the existing circle A is larger than the circle B, and hence image data is not overwritten with the circle B. Similarly, as illustrated in FIG. 1(d), still another point is selected and an inscribed circle C is drawn. In this case, the circle C is larger than the existing circle A, and hence the image data is overwritten with the circle C. Similarly, as illustrated in FIG. 1(e), still another point is selected and an inscribed circle D is drawn. In this case, a relationship of diameters of inscribed circles: circle C>circle D>circle A is satisfied, and hence the image data is overwritten with a region of the circle D other than a region thereof overlapping the circle C. Accordingly, the image data after the processing is as illustrated in FIG. 1(f). Such processing is repeated to the last to obtain a final image. Regarding the final image, ratios of the inscribed circles of the respective sizes occupying the image are obtained. The ratios are represented by a histogram and an average diameter is calculated. The above-mentioned image analysis can be performed through use of image analysis software such as ImageJ.

The sizes of the regions and inscribed circles thereof can be regulated by selecting the addition amount, particle diameter, surface treatment, dispersion method, and the like of the insulating fine particles. Specifically, the sizes of the regions and inscribed circles thereof can be decreased, for example, by increasing the addition amount of the insulating fine particles, reducing the particle diameter, and suppressing aggregation by performing surface treatment.

The thickness of the insulating film of the present invention is preferably 10 μm to 150 μm.

[Heat-Resistant Resin]

Examples of the heat-resistant resin include a polyimide resin, a polyamide imide resin, a polyether imide resin, a polyarylate resin, a polycarbonate resin, a polysulfone resin, and a polyphenylene sulfide resin. Of those, a polyimide resin and a polyamide imide resin are preferred. This is because those resins are excellent in heat resistance, mechanical strength, and insulating property. In the present invention, the heat-resistant resins may be used alone or in combination.

The polyimide resin can be obtained typically by preparing polyamide acid by polymerizing a tetracarboxylic dianhydride or a derivative thereof with a diamine compound, and then causing an imidization reaction to proceed by heating the polyamide acid.

Specific examples of the tetracarboxylic dianhydride include 3,3′,4,4′-biphenyltetracarboxylic dianhydride, pyromellitic dianhydride, 3,3′,4,4′-benzophenonetetracarboxylic dianhydride, 3,3′,4,4′-biphenyltetracarboxylic dianhydride, 2,3,3′,4-biphenyltetracarboxylic dianhydride, 2,3,6,7-naphthalenetetracarboxylic dianhydride, 1,2,5,6-naphthalenetetracarboxylic dianhydride, 1,4,5,8-naphthalenetetracarboxylic dianhydride, 2,2′-bis(3,4-dicarboxyphenyl)propane dianhydride, bis(3,4-dicarboxyphenyl) sulfone dianhydride, perylene-3,4,9,10-tetracarboxylic dianhydride, bis(3,4-dicarboxyphenyl) ether dianhydride, and ethylenetetracarboxylic dianhydride.

Specific examples of the diamine compound include p-phenylenediamine, 4,4′-diaminodiphenyl ether, 4,4′-diaminodiphenylmethane, 3,3′-diaminodiphenylmethane, 3,3′-dichlorobenzidine, 4,4′-diaminodiphenyl sulfide, 3,3′-diaminodiphenyl sulfone, 1,5-diaminonaphthalene, m-phenylenediamine, 3,3′-dimethyl-4,4′-biphenyldiamine, benzidine, 3,3′-dimethylbenzidine, 3,3′-dimethoxybenzidine, 4,4′-diaminodiphenyl sulfone, 4,4′-diaminodiphenyl sulfide, 4,4′-diaminodiphenylpropane, 2,4-bis(β-amino-t-butyl)toluene, bis(p-β-amino-t-butylphenyl) ether, bis(p-β-methyl-δ-aminophenyl)benzene, bis-p-(1,1-dimethyl-5-amino-pentyl)benzene, 1-isopropyl-2,4-m-phenylenediamine, m-xylylenediamine, p-xylylenediamine, di(p-aminocyclohexyl)methane, hexamethylenediamine, heptamethylenediamine, octamethylenediamine, nonamethylenediamine, decamethylenediamine, diaminopropyltetramethylene, 3-methylheptamethylenediamine, 4,4-dimethylheptamethylenediamine, 2,11-diaminododecane, 1,2-bis-3-aminopropoxyethane, 2,2-dimethylpropylenediamine, 3-methoxyhexamethylenediamine, 2,5-dimethylheptamethylenediamine, 3-methylheptamethylenediamine, 5-methylnonamethylenediamine, 2,11-diaminododecane, 2,17-diaminoeicosadecane, 1,4-diaminocyclohexane, 1,10-diamino-1,10-dimethyldecane, 1,12-diaminooctadecane, and 2,2-bis[4-(4-aminophenoxy)phenyl]propane.

The polyamide imide resin can be obtained by any appropriate synthesis method. Examples thereof include an acid chloride method involving subjecting trimellitic anhydride chloride and a diamine to a reaction, an isocyanate method involving subjecting trimellitic anhydride and a diisocyanate to a reaction, and a direct polymerization method involving subjecting trimellitic anhydride and a diamine to a reaction. Of those, an isocyanate method is preferred from the viewpoint of excellence in work efficiency.

Examples of the diisocyanate to be used in the case where the isocyanate method is adopted include: aromatic diisocyanates such as diphenylmethane diisocyanate, tolylene diisocyanate, tetramethylxylene diisocyanate, and 3,3′-dimethylbiphenyl-4,4′-diisocyanate; aliphatic diisocyanates such as ethylene diisocyanate, propylene diisocyanate, and hexamethylene diisocyanate; and alicyclic diisocyanates such as isophorone diisocyanate, hydrogenated xylylene diisocyanate, norbornene diisocyanate, and dicyclohexylmethane diisocyanate. Of those, diphenylmethane diisocyanate and dicyclohexylmethane diisocyanate are preferred from the viewpoint of excellence in cost.

The weight average molecular weight of each of the polyimide resin and the polyamide imide resin is preferably 35,000 to 75,000, more preferably 40,000 to 75,000, still more preferably 50,000 to 70,000, particularly preferably 55,000 to 67,000. When the weight average molecular weight is less than 35,000, the mechanical characteristics of a film to be obtained may become insufficient in some cases. Further, when the weight average molecular weight is more than 75,000, the viscosity increases, which may degrade workability and dispersibility of the insulating fine particles in some cases.

[Insulating Fine Particles]

The insulating fine particles are present so as to be dispersed in the heat-resistant resin and thereby suppress, for example, the development of an electrical tree in the insulating film. As a result, discharge deterioration is suppressed, which can extend the insulation life time.

The average primary particle diameter of each of the insulating fine particles is preferably 200 nm or less, more preferably 3 to 150 nm, stillmorepreferably 5 to 100 nm, particularly preferably 8 to 50 nm. When the average primary particle diameter is more than 200 nm, the effect of suppressing discharge deterioration is degraded, and a sufficient insulation life time may not be obtained in some cases. Herein, the average primary particle diameter can be obtained by measuring the major axes of 50 primary particles of the insulating fine particles and calculating an average value thereof in an image of a film cross-section obtained by transmission electron microscope observation.

A material for forming the insulating fine particles is not particularly limited, and examples of the material include silica, alumina, titania, boron nitride, magnesium hydroxide, aluminumhydroxide, and a layered silicate (clay). Of those, silica, alumina, and titania are preferred, and silica is more preferred from the viewpoint of excellence in dispersibility and insulating property.

Fumed silica, colloidal silica, or the like may be preferably used as the silica. As the silica, ones having various particle diameters are commercially available, and hence can be selected and used depending on purposes.

The insulating fine particles may be subjected to any appropriate surface treatment as needed. Examples of the surface treatment include the introduction of an amino group using an aminosilane compound and hydrophobization using trimethylsilane or the like. The surface treatments may be performed alone or in combination.

The content of the insulating fine particles in the insulating film of the present invention is preferably 1 to 18 parts by weight, more preferably 2 to 15 parts by weight, still more preferably 3 to 10 parts by weight with respect to 100 parts by weight of the resin solid content of the heat-resistant resin. When the content falls within such range, an insulating film excellent in mechanical characteristics and insulation life can be obtained. On the other hand, when the content is more than 18 parts by weight, the average diameter of inscribed circles of regions, which are free of the insulating fine particles, may be less than 80 nm in some cases.

[Production Method for Insulating Film]

The insulating film of the present invention can be produced, for example, by: adding the insulating fine particles to varnish of the heat-resistant resin (in the case of the polyimide resin, a polyamide acid solution as a precursor of the polyimide resin), followed by dispersing the insulating fine particles therein; applying the obtained varnish in which the insulating fine particles are dispersed onto a substrate, followed by drying the varnish; and releasing the dried film thus obtained (sometimes referred to as “semi-cured film”) from the substrate, followed by curing the film by heating.

The resin concentration of the varnish of the heat-resistant resin can be set to any appropriate value depending on purposes and the like. The resin concentration is generally 10 to 40% by weight. As each of a dispersion method for the insulating fine particles and an application method for the varnish in which the insulating fine particles are dispersed, any appropriate method can be adopted. For example, dispersion can be performed through use of any appropriate disperser such as a roll mill, a ball mill, a bead mill, or a nanomizer.

The drying temperature and time of the varnish in which the insulating fine particles are dispersed can be set appropriately depending on application thickness and the like. For example, when the polyamide imide resin is used as the heat-resistant resin, the drying temperature can be 50° C. to 200° C. Further, the drying time can be 10 minutes to 60 minutes. The drying temperature may be constant or changed in stages.

The heat-curing temperature and time of the dried film can be set appropriately depending on the thickness of the dried film and the like. For example, when the polyamide imide resin is used as the heat-resistant resin, the curing temperature can be 250° C. to 400° C. Further, the curing time can be 5 minutes to 60 minutes. When the dried film is cured by heating, it is preferred that the film be fixed so as not to shrink.

### EXAMPLES

Hereinafter, the present invention is described specifically by way of Examples. However, the present invention is by no means limited to Examples below. Note that measurement methods in Examples and the like are as follows.

### (1) Weight Average Molecular Weight

The weight average molecular weight was measured in terms of polyethylene oxide (PEO) through use of gel permeation chromatography (GPC). GPC conditions are as follows.

GPC device: Product name “HLC-8120GPC” (produced by Tosoh Corporation)

Column: “TSKgel superAWM-H”+“TSKgel superAW4000”+“TSKgel superAW2500” (produced by Tosoh Corporation)

Flow rate: 0.4 ml/min

Concentration: 1.0 g/l

Injection amount: 20 μl

Column temperature: 40° C.

Eluent: 10 mM LiBr+10 mM phosphoric acid/DMF

### (2) Insulation Life Time

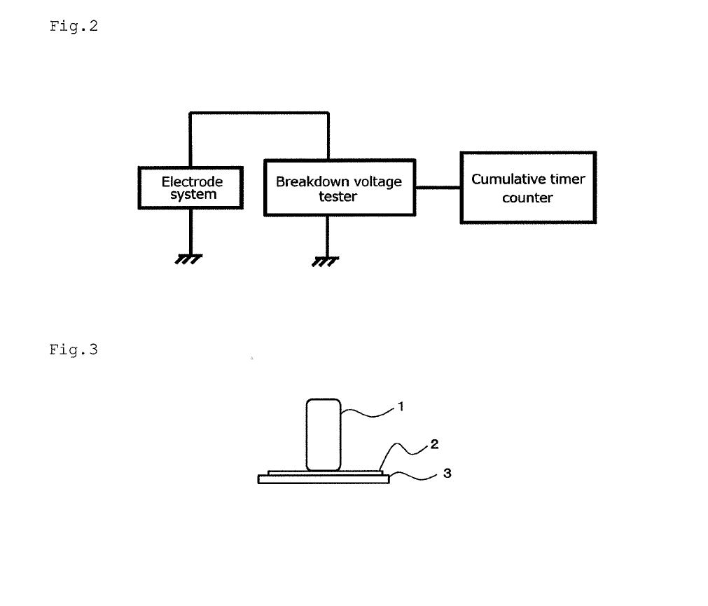

A period of time required for causing dielectric breakdown in a measurement sample at normal temperature and pressure was measured with an application voltage being set to an AC voltage of 3 kV through use of a breakdown voltage tester (product name “5051A”, produced by Tsuruga Electric Corporation). FIGS. 2 and 3 respectively illustrate a measurement circuit and an electrode arrangement. Twenty points on the measurement sample were measured and thereafter a Weibull distribution of breakdown time was created. A period of time required for a cumulative occurrence probability to reach 63.2% was defined as an average insulation life time.

### (3) Calculation of Average Diameter of Inscribed Circles of Regions, Which are Free of Insulating Fine Particles

An average diameter of inscribed circles of regions, which are free of insulating fine particles, was calculated by analyzing image data obtained by observing a cross-section of an insulating film with a transmission electron microscope (product No. “H-7650”, produced by Hitachi High-Technologies Corporation) through use of image analysis software (product name “ImageJ”).

### (4) Average Primary Particle Diameter

A film cross-section was observed at an acceleration voltage of 100 kV through use of a transmission electron microscope (product No. “H-7650”, produced by Hitachi High-Technologies Corporation). The major axes of 50 primary particles of insulating fine particles were measured on the basis of the obtained observed image, and an average value thereof was defined as an average primary particle diameter.

### Synthesis Example 1

To a four-necked flask equipped with a mechanical stirrer having a stirring blade, 1.00 mol of trimellitic anhydride (TMA), 1.00 mol of diphenylmethane diisocyanate (MDI), and 1,063 g of N-methyl-2-pyrrolidinone (NMP) were supplied, and the mixture was reacted at 120° C. for 2 hours. After that, the temperature of the mixture was raised to 180° C. and the mixture was further reacted for 3 hours at 180° C. Consequently, polyamide imide varnish was obtained. The weight average molecular weight of the obtained polyamide imide resin was 65,500. Further, the resin solid content of the obtained polyamide imide varnish was adjusted to 25% by weight, and the viscosity of the varnish (solvent: NMP) at 25° C. after the adjustment was measured through use of a digital viscometer HBDV-I Prime (produced by Brookfield Engineering Laboratories, Inc.) to be 66.4 Pa·s.

### Example 1

Nanosilica (product name “AEROSIL™RA200H”, produced by Nippon Aerosil Co., Ltd.) was added to the polyamide imide varnish of Synthesis Example 1 so that a filler amount with respect to the resin solid content became 2.5 parts by weight and dispersed in the varnish with a roll mill. The obtained silica dispersion varnish was applied onto a glass substrate so as to have a thickness of 50 μm after being dried. The silica dispersion varnish was heated at 80° C. for 15 minutes and then at 150° C. for 15 minutes and cooled to room temperature. After that, the silica dispersion varnish was released from the glass substrate. Thus, an independent semi-cured film was obtained. The semi-cured film was further heated at 340° C. for 15 minutes with an end portion thereof being fixed, whereby a cured film of polyamide imide was obtained.

### Example 2

A cured film of polyamide imide was obtained in the same way as in Example 1 except for adding nanosilica (product name “AEROSIL™RA200H”, produced by Nippon Aerosil Co., Ltd.) so that a filler amount with respect to the resin solid content became 5 parts by weight.

### Example 3

A cured film of polyamide imide was obtained in the same way as in Example 1 except for adding nanosilica (product name “AEROSIL™RA200H”, produced by Nippon Aerosil Co., Ltd.) so that a filler amount with respect to the resin solid content became 10 parts by weight.

### Comparative Example 1

A cured film of polyamide imide was obtained in the same way as in Example 1 except for adding nanosilica (product name “YA010C-SM1”, produced by Admatechs) so that a filler amount with respect to the resin solid content became 5 parts by weight.

### Comparative Example 2

A cured film of polyamide imide was obtained in the same way as in Example 1 except for adding nanosilica (product name “ADMAFINE SC1050-SXT”, produced by Admatechs) so that a filler amount with respect to the resin solid content became 5 parts by weight.

### Comparative Example 3

A cured film of polyamide imide was obtained in the same way as in Example 1 except for adding nanosilica (product name “ADMAFINE SC1050-SXT”, produced by Admatechs) so that a filler amount with respect to the resin solid content became 10 parts by weight.

### Comparative Example 4

A cured film of polyamide imide was obtained in the same way as in Example 1 except for adding nanosilica (product name “AEROSIL™RA200H”, produced by Nippon Aerosil Co., Ltd.) so that a filler amount with respect to the resin solid content became 20 parts by weight.

### Reference Example 1

A cured film of polyamide imide was obtained in the same way as in Example 1 except for not adding nanosilica.

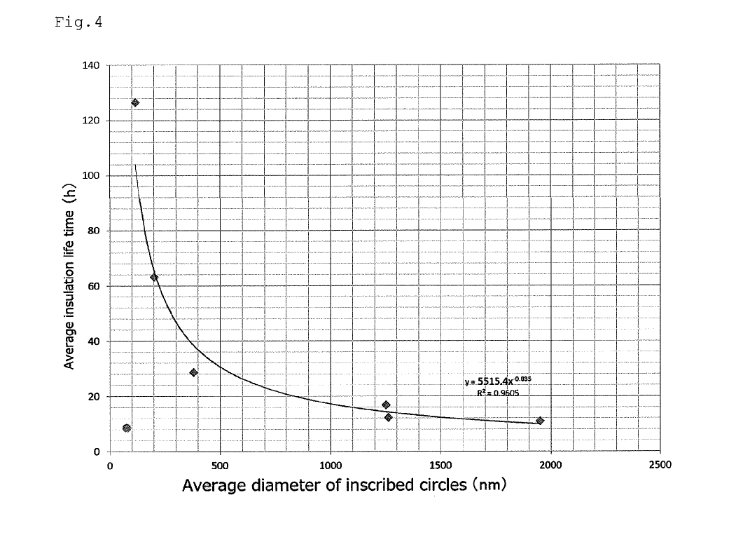

The cured films of polyamide imide obtained in Examples and Comparative Examples above were each measured for an average diameter of inscribed circles of regions, which are free of insulating fine particles, and average insulation life time. Table 1 shows the results. Further, FIG. 4 is a graph showing a relationship therebetween.

TABLE 1

| | | | | Comparative | Comparative | Comparative | Comparative | Reference |
|---|---|---|---|---|---|---|---|---|
| | Example 1 | Example 2 | Example 3 | Example 1 | Example 2 | Example 3 | Example 4 | Example 1 |
| Dispersion | Roll mill | Roll mill | Roll mill | Roll mill | Roll mill | Roll mill | Roll mill | — |
| method | | | | | | | | |
| Insulating | Fumed silica | Fumed silica | Fumed silica | VMC silica | VMC silica | VMC silica | Fumed silica | — |
| fine particle | RA200H | RA200H | RA200H | YA010C-SM1 | SC1050-SXT | SC1050-SXT | RA200H | — |
| Surface | Trimethylsilane | Trimethylsilane | Trimethylsilane | Phenylaminosi- | Phenylaminosi- | Phenylaminosi- | Trimethylsilane | — |
| treatment | Aminosilane | Aminosilane | Aminosilane | lane | lane | lane | Aminosilane | |
| Average | 12 | 12 | 12 | 10 | 205 | 205 | 12 | — |
| primary | | | | | | | | |
| particle | | | | | | | | |
| diameter | | | | | | | | |
| (nm) | | | | | | | | |
| Addition | 2.5 | 5 | 10 | 5 | 5 | 10 | 20 | 0 |
| amount | | | | | | | | |
| (parts) | | | | | | | | |
| Average | 381 | 201 | 116 | 1,250 | 1,950 | 1,260 | 76 | — |
| diameter of | | | | | | | | |
| inscribed | | | | | | | | |
| circle | | | | | | | | |
| (nm) | | | | | | | | |
| Average | 28.7 | 63.3 | 126.6 | 16.9 | 11.0 | 12.3 | 8.7 | 10.2 |
| insulation | | | | | | | | |
| life time | | | | | | | | |
| (h) | | | | | | | | |

*VMC: Vaporized Metal Combustion

As shown in Table 1 and FIG. 4, in the case where the average diameter of inscribed circles of regions, which are free of the insulating fine particles in the insulating film, is 900 nm or less, the resistance to discharge deterioration is excellent compared to that of the insulating film of Reference Example in which the insulating fine particles are not added, and an average insulation life time which is remarkably longer than that of the insulating film of Reference Example can be obtained. The reason that the long insulation life is obtained is presumed as follows. That is, it is considered that, in the insulating film of the present invention, the insulating fine particles are dispersed in the heat-resistant resin uniformly and densely, and hence the insulating fine particles not only suppress the development of an electrical tree in the film but also serve as a protective layer on the film surface to prevent the corrosion of the film surface by discharge. On the other hand, in Comparative Example 4 in which the average diameter of inscribed circles is less than 80 nm, micro cracks occurred in the film, and insulating property was degraded remarkably. It is understood from those results that, in a particular dispersion state in which the average diameter of inscribed circles of regions, which are free of the insulating fine particles in the insulating film, is 80 to 900 nm, very satisfactory insulating property is obtained.

### INDUSTRIAL APPLICABILITY

The insulating film of the present invention can be preferably used in automobile motors, industrial motors, inverters for large equipment, and the like.

### REFERENCE SIGNS LIST

1 electrode
2 measurement sample (insulating film)
3 frame ground

1. An insulating film, comprising: a heat-resistant resin; and an insulating fine particle dispersed in the heat-resistant resin, wherein an average diameter of inscribed circles of regions, which are free of the insulating fine particle, is from 80 to 900 nm.

2. An insulating film according to claim 1, wherein the heat-resistant resin contains at least one resin selected from a polyimide resin and a polyamide imide resin.

3. An insulating film according to claim 1, wherein the insulating fine particle has an average primary particle diameter of 200 nm or less.

4. An insulating film according to claim 1, wherein the insulating fine particle contains at least one component selected from silica, alumina, and titania.
